(19) United States
(12) Patent Application Publication
(10) Pub. No.: US 2004/0204221 A1
(43) Pub. Date: Oct. 14, 2004

(54) Set of lottery tickets and a game arrangement including such a set

(76) Inventor: Gert Eklund, Goteborg (SE)

Correspondence Address: OPPEDAHL AND LARSON LLP, P O BOX 5068, DILLON, CO, 80435-5068, US

(21) Appl. No.: 10/490,666

(22) PCT Filed: Sep. 26, 2002
(86) PCT No.: PCT/SE02/01758

(30) Foreign Application Priority Data
Sep. 26, 2001 (SE) 01031913

(51) Int. Cl. A63F 13/00

(52) U.S. Cl. 463/17

(57) ABSTRACT

Set of lottery tickets (7) in which each lottery ticket within said set of lottery tickets has a game field (2) which has a defined number of symbols (5) from a set of symbols and is covered by a scratch-off film of material which can be rubbed away, and a gaming arrangement (6) comprising such a set of lottery tickets.

### TECHNICAL FIELD

The present invention relates to a set of lottery tickets according to the preamble of patent claim 1 and to a gaming arrangement according to the preamble of patent claim 4.

### BACKGROUND ART

Lottery tickets having draw fields and/or game fields which are covered with a scratch-off film are already known. Draw field means a field which comprises a draw sequence in the form of a number of symbols. A draw field is therefore a field which has symbols which are used for generating a draw sequence. The draw sequence is applied to a game field in order, where appropriate, to generate a win. Game field therefore means a field where a draw sequence is to be applied in the actual game, whereupon a winning lottery ticket can be identified. The draw sequence includes a sequence of symbols which are compared with symbols located on the game field.

A problem with known lottery tickets having draw fields and/or game fields concealed behind a scratch-off film is that a winning lottery ticket can be directly identified if all the scratch-off surfaces are removed from the lottery ticket or if the lottery ticket is transparent, whereupon the symbols appear through the lottery ticket. This means that very stringent requirements are imposed on the quality of the material from which the lottery ticket and the scratch-off surface are made, which in turn increases the cost of production of lottery tickets. There is also still a problem in that there is a risk of misuse, where a player has in some way been able to identify winning lottery tickets before purchasing the lottery ticket.

### BRIEF DESCRIPTION OF THE INVENTION

It is an object of the invention to make available a set of lottery tickets eliminating the risk of misuse where a player has in some way been able to identify winning lottery tickets before purchasing the lottery ticket. This object is achieved by means of a set of lottery tickets according to the characterizing part of patent claim 1. According to the invention, each lottery ticket in the set of lottery tickets has identification markers arranged to uniquely distinguish draw fields from one another. By means of the identification markers, a winning lottery ticket can be distinguished from a non-winning lottery ticket only after use of a selection of draw fields. Moreover, a winning lottery ticket cannot be distinguished from a non-winning lottery ticket even when the whole of the scratch-off film is removed. In a draw sequence which takes place after the purchase, a selection of said set of identification markers is generated. This drawn selection of identification markers is communicated to the player via a transmission unit. By means of the identification markers, the player can select the draw fields which have been drawn. The symbols on said draw fields are thereafter compared with the symbols on the game field, whereupon a winning lottery ticket can be distinguished from a non-winning lottery ticket. The use of identification markers according to the invention ensures that a winning lottery ticket is not distinguishable from a non-winning lottery ticket even if the whole of the scratch-off film, thereby reducing the risk of misuse.

The invention also relates to a gaming arrangement comprising a transmission unit which is arranged to transmit a set of identification markers for application to the draw fields of the lottery tickets, winning lottery tickets being generated by means of the symbols on the draw fields being compared with the symbols located on the game fields. By virtue of the fact that only a selection of the draw fields is used, a winning lottery ticket can be distinguished from a non-winning lottery ticket only after identification of a set of drawn identification markers. Transmission unit means an apparatus which permits drawing of identification markers and communication of the drawn identification markers. A transmission unit thus comprises a database in which a set of identification markers is stored. A random generator in the transmission unit is arranged to generate a selected set of identification markers. The transmission unit further comprises a sender unit via which the selected set of identification markers is transmitted. The sender is of a type known per se and can consist of a TV camera coupled to a terrestrial, satellite or cable TV network, a computer-based network, or a microphone coupled to a radio transmitter. To receive the signal emitted by the transmission unit and including information on the selected identification markers, receiver units for this purpose are provided which are of a known type and can include a TV receiver via cable or aerial, a radio receiver or a computer connected to a computer network.

### DESCRIPTION OF THE FIGURES

The invention will be described in more detail with reference to the attached figures in the drawing, where

FIG. 1 shows a lottery ticket included in a set of lottery tickets;

FIG. 2 shows an enlarged view of the area I in FIG. 1,

FIG. 3 shows an enlarged view of the area II in FIG. 1,

FIG. 4 shows a gaming arrangement, and

FIG. 5 shows an apparatus for generating a set of lottery tickets.

### ILLUSTRATIVE EMBODIMENT

The invention relates to a lottery ticket where game fields and/or draw fields are covered by a scratch-off film despite the fact that a winning lottery ticket cannot be distinguished from a non-winning lottery ticket before transmission of a draw sequence including game symbols on the game field or identification markers on draw fields. In the figures below, an embodiment of a set of lottery tickets is described in which the invention is used.

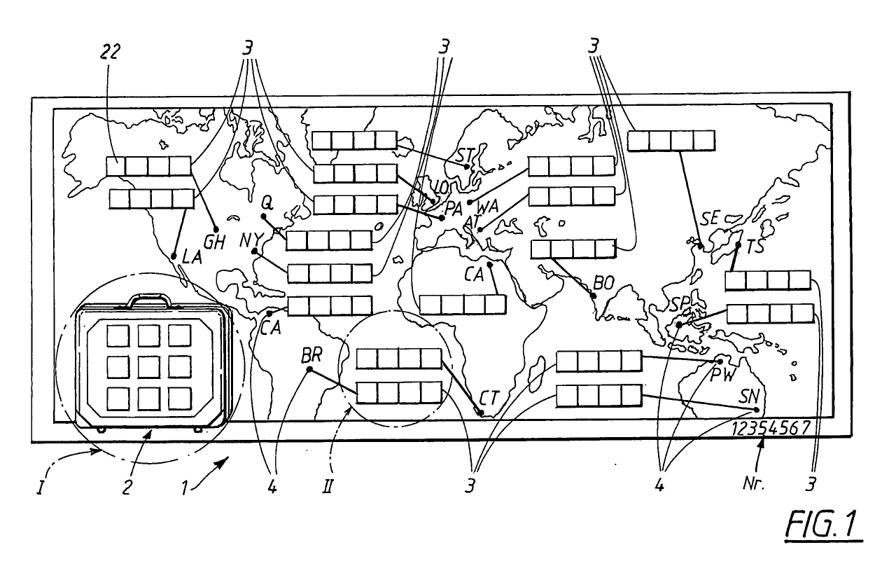

In FIG. 1, a lottery ticket 1 with a game field 2 and a number of draw fields 3 is shown. Each draw field 3 has an identification marker 4, the purpose of which is to uniquely distinguish draw fields from one another. According to one embodiment, the same set of identification markers is used on all lottery tickets included in a set of lottery tickets, although it can also vary from lottery ticket to lottery ticket. According to one embodiment of the invention, each draw field 3 has a random number of symbols selected from a set of symbols. There are preferably between 1 and 4 symbols on each draw field. In the event that a random number of symbols are present on each draw field, however, the total number of symbols on all the draw fields on a lottery ticket can be constant. The total number of symbols on the lottery ticket exceeds the number of symbols on the draw field. This can be achieved by the fact that the randomization process in which the number of symbols on each draw field is determined has, as boundary condition, that the sum of the number of symbols on each lottery ticket is constant. An example of such a process can be j=(p(j)*n/Σp(i)), where p(j) is a random distribution function with outcomes between 0 and 1, n is the total number desired and the summation is performed across all outcomes of p(j). For each field j, a figure is generated which corresponds to the desired total number n multiplied by the proportion of this which each field is intended to carry. The number can thereafter be rounded off to a whole number while maintaining the criterion that the sum of the number of fields must be equal to the given number n. The rounding-off can be done in accordance with conventional rules. If the sum is too low, the draw fields whose non-rounded numbers were nearest to being rounded off can be corrected in order instead to be rounded upward. If the sum is too high, the correction can be done in the reverse way.

According to an alternative embodiment of the invention, the total number of symbols on the draw fields in a set of lottery tickets of defined size can be fixed without the above-indicated requirement that the total number of symbols on all draw fields on a lottery ticket must be constant. A distribution function in accordance with what has been described above can be used, but with the restriction that the total sum of the number of symbols on all draw fields included in the set of lottery tickets must be constant. A set of lottery tickets means a quantity of lottery tickets which are supplied for a game and which satisfy the lottery organizer's requirements for statistical spread of the configuration of the lottery tickets. The set of lottery tickets preferably has a controlled win plan. A set of lottery tickets is not a random or specific selection from a quantity of lottery tickets supplied for a game.

In FIG. 1, all the draw fields 3 and the game field 2 are covered by a scratch-off film 5, for which reason no symbols are visible. FIG. 1 also shows a preferred embodiment of the invention in which the lottery ticket has a design representing a large geographic area, in this case the world with its five continents. The identification markers 4 consist of demarcated geographic areas within said large geographic area, in this case cities.

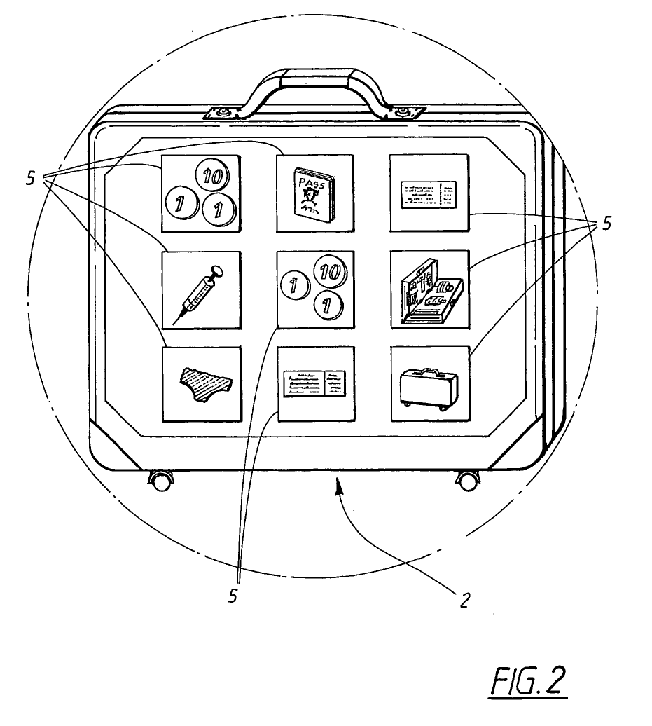

FIG. 2 shows an enlarged view of the area I in FIG. 1. The figure shows a game field 2 in the form of a suitcase comprising a defined number of symbols 5 randomly selected from a set of symbols. In the embodiment shown here, the set of symbols consists of a collection of symbols related to travel. In the example, two symbols are shown representing money, one representing a passport, one symbol representing a suitcase, one symbol representing swimming trunks, one symbol representing a toilet bag, one symbol representing a vaccination syringe, and two symbols representing travel tickets.

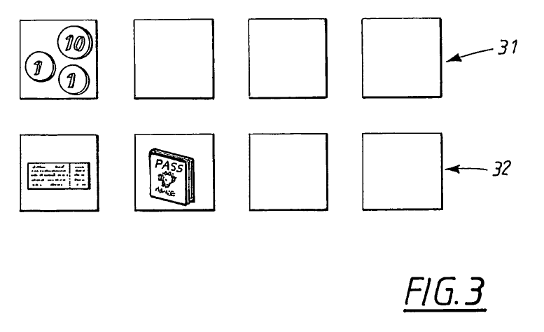

FIG. 3 shows an enlarged view of the area 11 in FIG. 1. The figure shows two draw fields 31, 32, the first draw field 31 having one symbol from a set of symbols, and the second draw field having two symbols from a set of symbols. According to the invention, a random number of symbols are placed on each draw field. In a preferred embodiment of the invention, there are one or more symbols, preferably a maximum of 4 symbols, on each draw field. According to a preferred embodiment of the invention, each one of the lottery tickets in the set of lottery tickets has more draw fields than there are symbols on the game field. FIG. 3 also shows a receiving unit 24 which is arranged to receive a set of identification markers 4 selected and transmitted from the sender unit.

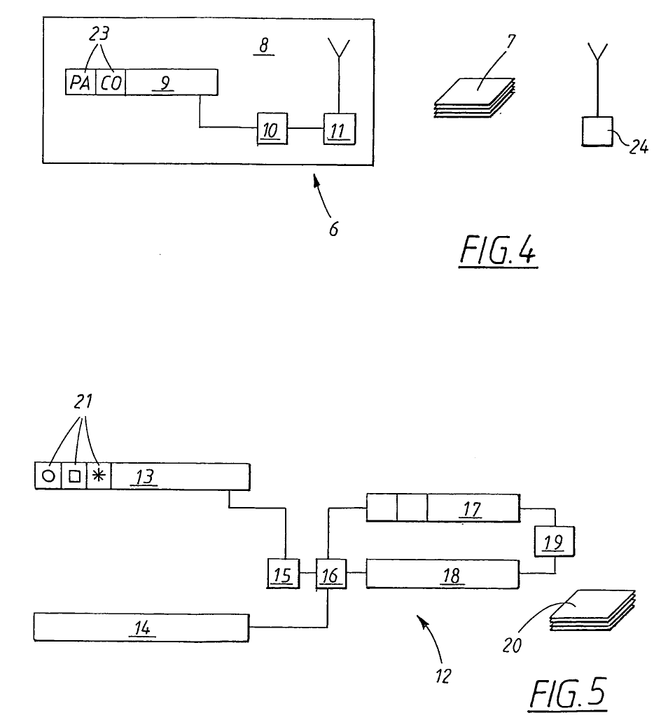

FIG. 4 shows a gaming arrangement 6 comprising a set of lottery tickets 7 of the type which has been described above. The gaming arrangement 6 also comprises a transmission unit 8 which is arranged to transmit a set of identification markers for application on said draw fields, with winning lottery tickets being generated by means of the symbols on the draw fields being compared with the symbols located on the game fields. The transmission unit 8 therefore comprises a register 9 in which identification markers for the draw fields located on the lottery tickets are stored. The transmission unit 8 also comprises a random generator 10 which is arranged to generate a set of identification markers 4 from the identification markers stored in the register. The register according to a first embodiment comprises at least 10, preferably at least 20, identification markers. The transmission unit 8 further comprises a sender unit 11 via which the generated sequence of identification markers is transmitted. The sender is of a type known per se and can consist of a TV camera coupled to a terrestrial, satellite or cable TV network or to a computer-based network.

FIG. 5 shows an apparatus for generating a set of lottery tickets. The apparatus 12 comprises a first register 13 which comprises all the symbols included in a set of symbols. In a preferred embodiment of the invention, the set of symbols comprises at least 6 different symbols. In a further preferred embodiment, the set of symbols comprises at least 12 different symbols. The apparatus also comprises a second register comprising all identification markers. A random generator 15 is also provided in order to generate a random number of symbols for each identification marker. A generating processor 16 thus generates for each lottery ticket a vector (25) which comprises information on identification number No. (FIG. 1) of a lottery ticket and symbols included in each identification marker. This information is stored in a first memory 17. The generating processor also generates a game field comprising a defined number of symbols from the set of symbols. This information is stored in a second memory 18 together with information on identification number No. (FIG. 1) of the lottery tickets. A printer 19 uses the information in the first and second memories 17, 18 and a set of lottery tickets 20 can be generated. The vectors located in the first memory 17 are used to generate draw fields (3) of the set of lottery tickets (7). The information located in the second memory 18 is used to generate game fields (3) of the set of lottery tickets (7).

1. A set of lottery tickets (7) in which each lottery ticket (1) within said set of lottery tickets (7) has a game field (2) which has a defined number of symbols (5) from a set of symbols (21), a number of draw fields (3) having at least one symbol (5) from said set of symbols (21), and a scratch-off film (22) of material which can be rubbed away and which covers the game field (2) and the draw fields (3), wherein each lottery ticket (1) also has identification markers (4) which are arranged to distinguish draw fields (3) from each other, said identification markers (4) ensuring that only after a selection of the draw fields (3) has been used is it possible for a winning lottery ticket to be distinguished from a non-winning lottery ticket, and a winning lottery ticket cannot be distinguished from a non-winning lottery ticket even if the whole of the scratch-off film is removed.

2. The set of lottery tickets as claimed in claim 1, wherein each of said draw fields (3) has a random number of symbols (5) from said set of symbols (21).

3. The set of lottery tickets as claimed in claim 1, wherein each of the lottery tickets in the set of lottery tickets (7) has more draw fields (3) than there are symbols (5) on the game field (2).

4. A gaming arrangement (6) comprising a set of lottery tickets (7) as claimed in claim 1 and a transmission unit (8) which comprises a register (9) in which a set (23) of identification markers (4) are stored, a random generator (10) arranged to generate a selected set of identification markers (4), and a sender unit (11) via which the selected set of identification markers (4) is transmitted, the transmission unit (8) being arranged to transmit a set of identification markers (4) for application to said draw fields (3).

5. The gaming arrangement as claimed in claim 4, characterized in that the gaming arrangement comprises a set of receiving units (24) which are arranged to receive, from the sender unit (11), the selected set of identification markers (4), after which winning lottery tickets are identified by means of the symbols (5) on the draw fields (3), which have been identified by the transmitted set of identification markers (4), being compared with the symbols located on the game fields (2).

6. The gaming arrangement of claim 4, wherein in the set of lottery tickets each of said draw fields (3) has a random number of symbols (5) from said set of symbols (21).

7. The gaming arrangement as claimed in claim 6, characterized in that the gaming arrangement comprises a set of receiving units (24) which are arranged to receive, from the sender unit (11), the selected set of identification markers (4), after which winning lottery tickets are identified by means of the symbols (5) on the draw fields (3), which have been identified by the transmitted set of identification markers (4), being compared with the symbols located on the game fields (2).

8. The gaming arrangement of claim 4, wherein in the set of lottery tickets each of the lottery tickets (7) has more draw fields (3) than there are symbols (5) on the game field (2).

9. The gaming arrangement as claimed in claim 8, characterized in that the gaming arrangement comprises a set of receiving units (24) which are arranged to receive, from the sender unit (11), the selected set of identification markers (4), after which winning lottery tickets are identified by means of the symbols (5) on the draw fields (3), which have been identified by the transmitted set of identification markers (4), being compared with the symbols located on the game fields (2).

10. The set of lottery tickets as claimed in claim 2, wherein each of the lottery tickets in the set of lottery tickets (7) has more draw fields (3) than there are symbols (5) on the game field (2).
